(19) United States
(12) Patent Application Publication
(10) Pub. No.: US 2021/0318412 A1
(43) Pub. Date: Oct. 14, 2021

(54) APPARATUS AND METHOD FOR PROCESSING RADAR DATA AND RADAR SYSTEM

(71) Applicant: Robert Bosch GmbH, Stuttgart (DE)

(72) Inventors: Tobias Strauss, Obersulm (DE); Philipp Klippel, Erdmannhausen (DE)

(21) Appl. No.: 17/196,594

(22) Filed: Mar. 9, 2021

(30) Foreign Application Priority Data
Apr. 9, 2020 (DE) 102020204592.5

(51) Int. Cl. G01S 7/292; G01S 13/524

(52) U.S. Cl. CPC G01S 7/292; G01S 13/931; G01S 13/5248

(57) ABSTRACT

The processing of radar data of a radar sensor. By adaptively adjusted assignment of the radar data to a radar cluster, the volume of radar data of the radar sensor is able to be reduced. The radar data are assigned to an already existing radar cluster, if a suitable association is detected between the radar data of the radar sensor and an already existing radar cluster. Otherwise, a new radar cluster may be created with the radar data.

### CROSS REFERENCE

The present application claims the benefit under 35 U.S.C. § 119 of German Patent Application No. DE 102020204592.5 filed on Apr. 9, 2020, which is expressly incorporated herein by reference in its entirety.

### FIELD

The present invention relates to an apparatus and a method for processing radar data. In addition, the present invention relates to a radar system having integrated processing of the radar data.

### BACKGROUND INFORMATION

German Patent Application No. 10 2014 205 180 A1 describes a method and a device for operating a vehicle that has various environmental sensors for sensing a driving environment. Specifically, it is described to fuse data of several driving-environment sensors together and to identify an object on the basis of the fused data.

For complete or at least partially autonomous driving, as well as for applications in the area of driver assistance, precise knowledge of the position and orientation of the ego vehicle is advantageous. For example, in addition to satellite-based systems, feature-based localization systems may also be used for this purpose. Such systems require a feature map of the vehicle environment that is as complete and up-to-date as possible. For example, sensor data of a vehicle fleet such as radar data, for instance, may be used for producing such feature maps. At the same time, in order to keep the exchange of data by the vehicles in the fleet as minimal as possible, it is desirable to compress the sensor data in suitable manner.

### SUMMARY

The present invention provides an apparatus and a method for processing radar data, as well as a radar system. Further advantageous specific embodiments are also provided and are described herein.

In accordance with an example embodiment of the present invention, an apparatus for processing radar data, having a storage device and a processing device, is provided. The storage device is designed to store radar data of at least one radar cluster. The processing device is designed to receive radar data from a radar sensor and to compare the radar data received to radar data of at least one radar cluster stored previously. Furthermore, the processing device is designed to assign the radar data received to a radar cluster stored previously, if a link has been detected between the radar data received and a corresponding radar cluster stored previously. The processing device is also designed to create a new radar cluster if no link has been detected between the radar data received and the at least one radar cluster stored previously.

In accordance with an example embodiment of the present invention, a radar system having a radar sensor and an apparatus according to the present invention for processing radar data. The radar sensor is designed to provide radar data of objects within a sensing range of the radar sensor to the apparatus for processing the radar data.

In accordance with an example embodiment of the present invention, a method is provided for processing radar data, having the steps of receiving radar data from a radar sensor and comparing the radar data received to radar data of at least one radar cluster stored previously. Furthermore, the method includes a step of assigning the radar data received to a radar cluster stored previously, if a link has been detected between the radar data received and a corresponding radar cluster stored previously. In addition, the method includes a step of creating a new radar cluster if no link has been detected between the radar data received and the at least one radar cluster stored previously.

The present invention is based on the knowledge that a radar sensor is usually able to detect a high number of individual targets and provide corresponding radar data for each of these individual targets. Because of this possibly very high number of individual targets, the radar sensor therefore supplies a large volume of data. Further processing and especially transmission of the radar data to further systems thus requires a high transmission capacity.

Therefore, in accordance with an example embodiment of the present invention, this knowledge is taken into account and processing of radar data is provided which is able to quickly and efficiently compress the radar data provided by a radar sensor. In this context, by efficiently combining the radar data to form what are referred to as radar clusters, in particular, the radar data are compressed in such a way that efficient further processing of the radar data in such radar clusters may also be realized. Thus, on one hand, the volume of data in the form of radar data output by the radar sensor is able to be compressed, and moreover, the radar data thus compressed in radar clusters may be further processed in especially efficient and purposeful manner, as well.

If radar data with respect to a plurality of point targets are combined in one mutual cluster, then it is sufficient for the portions of the radar data in common for all individual targets to be stored only once. In this way the volume of data may be reduced significantly, especially for large, extended objects. In addition, if it is known that several individual targets belong to one mutual object, then this information may also be used for efficient further processing of the radar data of such a radar cluster.

According to one specific embodiment of the present invention, the radar data include at least data of a spatial position and an effective radar cross-section (RCS) of a target object. For instance, the spatial position may be specified in the form of a distance as well as an azimuth- and elevation angle. Naturally, any other specifications for the spatial position of a target object are possible, as well. Moreover, if applicable, the radar data may also include further information such as information about an ambiguity or measurement inaccuracies.

According to one specific embodiment of the present invention, a radar cluster includes radar data of a number of one or more target objects. In particular, by combining the radar data of a plurality of target objects in one mutual radar cluster, portions of the radar data in common for all target objects may be stored only once in the radar cluster. Moreover, such a radar cluster with the radar data specified therein may also already indicate that the radar data of all target objects contained in the radar cluster have shared characteristics. For instance, this information may be utilized for further processing of the radar data in such a radar cluster.

For example, a radar cluster may contain radar data of various individual targets which relate to one shared object. As an example, the radar data of several individual targets of one object like, e.g., a road sign, a guard rail, a building, a vehicle or the like, may be combined in one corresponding radar cluster.

According to one specific embodiment of the present invention, the processing device is designed to sort the radar data received and/or the radar data of the stored radar clusters. In this case, the radar data received may be compared to the radar data of the stored radar clusters, utilizing the sorted radar data and/or the sorted radar clusters. By suitable sorting of the radar data and/or the radar clusters, it is possible, e.g., to bring the radar data and the data of the radar clusters into one identical or at least similar sequence. The associating of radar data with suitable radar clusters may thus be accelerated.

According to one specific embodiment of the present invention, in each case the processing device compares received radar data to only a subset of a sorted list of radar clusters. In particular, the radar data received from the radar sensor may also be sorted in advance, and thereupon in each case only a subset of the sorted radar data received may be compared to a suitable subset of the sorted radar clusters. The required number of comparison operations or associations between the radar data received and the data clusters may thus be reduced considerably.

Any suitable parameters may be utilized for sorting the received radar data and/or the radar clusters. For instance, the radar data and/or the radar clusters may be sorted according to their spatial position, particularly the distance between the target object and the radar sensor, as well as the azimuth- and/or elevation angle, effective radar cross-section and/or any other suitable parameters.

According to one specific embodiment of the present invention, the radar data received are compared to the radar data of the radar clusters stored previously, utilizing the respective spatial position, the effective radar cross-section and/or a measuring characteristic of the radar sensor for acquiring the radar data. In particular, radar data of individual targets which have identical, analogous or at least similar attributes, e.g., a high RCS in approximately identical spatial position and/or distance, or the like, may be assigned to one mutual radar cluster.

According to one specific embodiment of the present invention, the radar data received may be compared to the radar data of the radar clusters stored previously, utilizing an object classification, external environmental information and/or a modeling of the sensor surroundings. For instance, individual targets having similar RCS may be assigned to approximately punctiform objects such as posts or the like, while objects having rather low RCS values may be assigned to extended objects such as curbs or the like. If desired, information from other driving environment sensors such as a camera or ultrasonic sensor, for example, may also be included in order to obtain further information about objects in the surroundings of the radar sensor, which may be utilized for grouping radar data into radar clusters. In addition, for example, the processing device may incorporate a known model of the surroundings, or optionally, may also model the sensor surroundings in real time, which may be utilized for combining the radar data into radar clusters.

According to one specific embodiment of the present invention, the radar data received may be compared to the radar data of the radar clusters stored previously, utilizing a direction of movement and/or speed of movement. For example, the movement information may be utilized for characterizing objects in the sensor environment and consequently corresponding radar clusters. Particularly in suitable application cases it may be assumed, for example, that objects extend chiefly in the longitudinal direction parallel to a direction of movement (e.g., curbs or the like). Moreover, since the absolute or relative speed of objects likewise has an influence on the radar signals, the speed of movement of the sensor, or rather the speed of a vehicle having the sensor, may also be incorporated into the processing.

In this context, the individual criteria for assigning the radar data to radar clusters may, in particular, be adjusted dynamically during operation. Thus, for example, information from the radar data of already existing radar clusters may be utilized to compare the newly received radar data to this information, and from that, to suitably associate the radar data with radar clusters. In addition, information about instantaneous operating states or changes like, e.g., changes in the direction of movement, the speed, or in the surroundings of the radar sensor may also be taken into account, in order to dynamically adjust the association between the radar data and the radar clusters.

The embodiments and further developments above may be combined with each other in any way desired, in so far as reasonable. Additional embodiments, further developments and implementations of the present invention also include combinations, not explicitly named, of features of the invention described previously or in the following in connection with the exemplary embodiments. In particular, in this context, one skilled in the art will also add individual aspects as improvements to or supplementations of the respective basic forms of the present invention, in view of the disclosure herein.

### BRIEF DESCRIPTION OF THE DRAWINGS

The present invention is explained in greater detail below on the basis of the exemplary embodiments shown in the schematic figures.

FIG. 1 shows a schematic representation of a block diagram of a radar system having an apparatus for processing radar data according to one specific embodiment of the present invention.

FIG. 2 shows a schematic representation of a flowchart as underlies a method for processing radar data according to one specific embodiment of the present invention.

### DETAILED DESCRIPTION OF EXAMPLE EMBODIMENTS

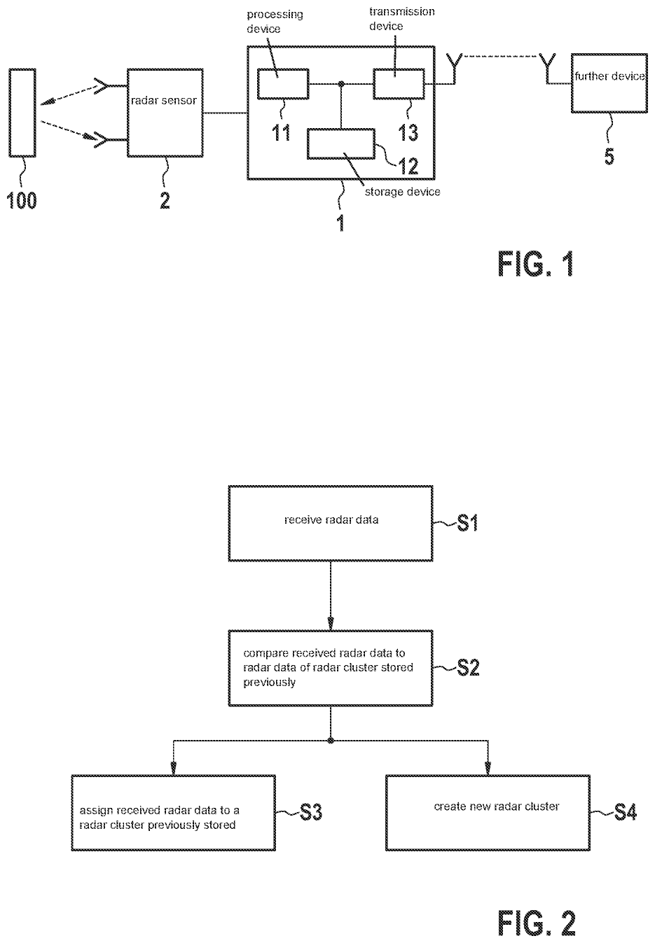

FIG. 1 shows a schematic representation of a block diagram of a radar system having an apparatus 1 for processing radar data according to one specific embodiment of the present invention. The radar system may include a radar sensor 2 as well as an apparatus 1 for processing the radar data of radar sensor 2. Radar sensor 2 may be any radar sensor, e.g., a radar sensor of a vehicle driving in completely or partially autonomous fashion. For example, radar sensor 2 may emit radar signals, which are reflected entirely or in part by an object 100. The reflected radar signals may thereupon be received by radar sensor 2 and compared to the emitted signals. On this basis, for example, radar sensor 2 is able to detect individual point targets. For instance, for each detected point target, radar sensor 2 is able to output radar data. For example, the radar data may include a spatial position, e.g., in the form of a distance as well as an angle in the form of an azimuth- and elevation angle. Naturally, any other data concerning the spatial position of a detected point target are also possible. Moreover, the radar data may include an effective radar cross-section (RCS), for example, and possibly further parameters as well, such as measurement uncertainties or information about possible ambiguities. Naturally, the radar data may also include any other suitable information about a detected point target.

The radar data determined by radar sensor 2 are then made available to apparatus 1 for the processing of radar data. For example, apparatus 1 for processing radar data may include a processing device 11 and a storage device 12. If desired, apparatus 1 may also include a transmission device 13 and potentially further components. For instance, transmission device 13 may transmit the radar data processed by apparatus 1 to a further device 5, e.g., a cloud, a data-processing center or the like. In so doing, in particular the transmission may take place in wireless fashion, e.g., with the aid of a cellular communication or the like. In principle, any other transmission paths, especially wireless or wired transmissions between apparatus 1 and further device 5 are also possible. For instance, further device 5 may evaluate the data received and, e.g., create a feature map based on the data received. However, any other evaluations and processing of the radar data received are, of course, possible as well.

Processing device 11 is able to receive the radar data provided by radar sensor 2. This radar data may be assigned by processing device 11 specifically to radar clusters. In this way, radar data, especially radar data of a plurality of point targets, may be grouped. In this case, the association or assignment of the radar data to a radar cluster may be adaptively adjusted. To that end, for example, processing device 11 may compare the radar data received from radar sensor 2, to radar clusters already stored previously. For instance, the previously stored radar clusters may be stored in storage device 12. Any suitable data format may be provided for storing the radar clusters in storage device 12.

For instance, processing device 11 may associate the effective radar cross-section and the spatial position, e.g., in the form of distance as well as azimuth- and elevation angle, with the information of the radar clusters already identified. If a suitable connection is determined between the radar data received from radar sensor 2 and an already existing radar cluster, then the corresponding radar data may be added to the respective radar cluster. Alternatively, if no radar cluster is able to be connected to the current radar data received, a new radar cluster may be created, into which the received radar data are integrated. The augmented or newly created radar cluster may then be stored in storage device 12.

Any suitable information may be utilized for associating the received radar data with the radar clusters. In particular, the association between radar data and radar clusters may be adaptively adjusted. For instance, information about the measuring characteristic of radar sensor 2 may be utilized for that purpose. For example, the association between radar data and radar clusters may take into account that with increasing measuring distance, the angular resolution of radar sensor 2 leads to greater radial measurement uncertainties, or that certain attributes like, e.g., the RCS, are dependent on the viewing angle and the distance.

Moreover, the association between radar data and radar clusters may also take into account that different object classes have different RCS values. Thus, for instance, punctiform objects like, e.g., a post in a top view, have a high RCS value, while extended objects like, e.g., curbs or the like, have a rather low RCS value.

In addition, the direction of movement as well as the speed of movement of the radar sensor in relation to the surroundings may also be taken into account. Particularly in sensing a vehicular environment of a moving vehicle, a large number of objects may possibly have an alignment parallel to the direction of travel and therefore parallel to the roadway. For example, guard rails or curbs, but also house façades very often run along the direction of travel. Likewise, an instantaneous speed of the radar sensor, e.g., the speed of the ego vehicle having radar sensor 2, may have an effect on measurement inaccuracies. Particularly at relatively low speeds, for example, a static environment can no longer be resolved very well spatially. This may also be utilized in adjusting the parameters for associating the radar parameters with a radar cluster.

Moreover, information of other sensors like, e.g., a camera or ultrasonic sensors, which likewise sense the area surrounding a radar sensor, may also be utilized for assigning the radar data to a radar cluster.

In addition, model data may also be included in the association of the radar data with radar clusters. For instance, an already previously-known model of an area surrounding radar sensor 2 may be utilized to optimize the assignment of the radar data to a radar cluster. However, dynamic modeling of the area surrounding radar sensor 2, especially in real time, is also possible in order to provide additional information for associating the radar data with the radar clusters.

It is possible to compare all radar data of radar sensor 2 to all radar clusters already existing, in order to attain a suitable association. However, to further optimize the comparison and the association of the radar data with the radar clusters, the radar data and/or the radar clusters already existing may be sorted in suitable manner. After the radar data and/or the radar clusters are available in sorted form, it may be sufficient to compare only a subset of the radar clusters to radar data. Namely, one radar-data record or a subset of the radar data provided by radar sensor 2 may be compared to a suitable subgroup of the sorted radar clusters. In principle, any suitable feature is possible for the sorting and assignment of suitable radar data to suitable subsets of radar clusters. For instance, the radar data and/or the radar clusters may be sorted on the basis of the spatial position, e.g., distance and/or azimuth- and elevation angle. However, sorting on the basis of the RCS values is possible, as well. Moreover, it is also possible to sort the already-existing radar clusters on the basis of a suitable object classification, according to its spatial extension or any other suitable criteria.

After the radar data and/or the radar clusters have been sorted in suitable manner, in each case an appropriate subset of radar clusters may be determined for a record of radar data. For example, from the sorted list of radar clusters, those radar clusters may be selected whose characteristics move within a predetermined value range according to the corresponding characteristics of the radar data. Thus, it is sufficient to compare only the corresponding subset of radar clusters to the respective radar data in order to permit a suitable association of the radar data with the radar clusters. As a result, the processing speed may be increased and the computing power for associating the radar data with the radar clusters may be reduced.

FIG. 2 shows a schematic representation of a flowchart as underlies a method for processing radar data according to one specific embodiment of the present invention. In principle, the method for processing the radar data may include any steps as have already been described previously in connection with the radar system. Analogously, the radar system may also have any given components in order to carry out operations as described in the following in connection with the method.

In step S1, radar data are received from a radar sensor 2. In step S2, the radar data received are compared to radar data of at least one radar cluster stored previously. Subsequently, in step S3, the radar data received may be assigned to a radar cluster stored previously, if a link has been detected between the radar data received and the corresponding radar cluster stored previously. Alternatively, in step S4, a new radar cluster may be created if no link has been detected between the radar data received and the at least one radar cluster stored previously.

In summary, the present invention relates to the processing of radar data of a radar sensor. By adaptively adjusted assignment of the radar data to a radar cluster, the volume of radar data of the radar sensor may be reduced. In particular, it is provided to assign the radar data to an already existing radar cluster, if a suitable association is detected between the radar data of the radar sensor and an already existing radar cluster. Otherwise, a new radar cluster may be created with the radar data.

What is claimed is:

1. An apparatus for processing radar data, comprising:
a storage device configured to store radar data of at least one radar cluster; and
a processing device configured to:
receive radar data from a radar sensor,
compare the radar data received to radar data of at least one radar cluster stored previously,
assign the radar data received to a radar cluster stored previously, if a link has been detected between the radar data received and a corresponding radar cluster of the at least one radar cluster stored previously, and
create a new radar cluster if no link has been detected between the radar data received and the at least one radar cluster stored previously.

2. The apparatus as recited in claim 1, wherein the radar data include data of a spatial position and an effective radar cross-section of a target object.

3. The apparatus as recited in claim 1, wherein each radar cluster includes radar data of a number of one or more target objects.

4. The apparatus as recited in claim 1, wherein the processing device is configured to sort the radar data received and/or the radar data of the at least one radar cluster stored previously, and to compare the radar data received to the radar data of the at least one radar cluster stored previously, utilizing the sorted radar data and/or the sorted radar clusters.

5. The apparatus as recited in claim 4, wherein in each instance, the radar data received are compared only to a subset of the sorted radar clusters.

6. The apparatus as recited in claim 1, wherein the radar data received are compared to the radar data of the radar clusters stored previously, utilizing the respective spatial position, the effective radar cross-section and/or a measuring characteristic of a radar sensor for acquiring the radar data.

7. The apparatus as recited in claim 1, wherein the radar data received are compared to the radar data of the at least one radar cluster stored previously, utilizing an object classification and/or external environmental information and/or a modeling of sensor surroundings.

8. The apparatus as recited in claim 1, wherein the radar data received are compared to the radar data of the at least one radar cluster stored previously, utilizing a direction of movement and/or speed of movement.

9. A radar system, comprising:
a radar sensor configured to provide radar data of objects within a sensing range of the radar sensor; and
an apparatus for processing the provided radar data, the apparatus including:
a storage device configured to store radar data of at least one radar cluster, and
a processing device configured to:
receive radar data from a radar sensor,
compare the radar data received to radar data of at least one radar cluster stored previously,
assign the radar data received to a radar cluster stored previously, if a link has been detected between the radar data received and a corresponding radar cluster of the at least one radar cluster stored previously, and
create a new radar cluster if no link has been detected between the radar data received and the at least one radar cluster stored previously.

10. A method for processing radar data, comprising the following steps of:
receiving radar data from a radar sensor;
comparing the radar data received to radar data of at least one radar cluster stored previously;
assigning the radar data received to a radar cluster stored previously, when a link has been detected between the radar data received and a corresponding radar cluster of the at least one radar cluster stored previously; and
creating a new radar cluster when no link has been detected between the radar data received and the at least one radar cluster stored previously.
